(19) United States
(12) Patent Application Publication
(10) Pub. No.: US 2013/0010138 A1
(43) Pub. Date: Jan. 10, 2013

(54) Digital Camera with an Image Processor

(76) Inventors: Petronel Bigioi, Galway (IE); Alexei Pososin, Galway (IE); Mihnea Gangea, Bucuresti (RO); Stefan Petrescu, Bucuresti (RO); Peter Corcoran, Claregalway (IE); Alexandru Drimbarean, Galway (IE); Adrian Zamfir, Bucuresti (RO); Corneliu Florea, Bucuresti (RO)

(21) Appl. No.: 13/442,721

(22) Filed: Apr. 9, 2012

Related U.S. Application Data
(63) Continuation-in-part of application No. 11/841,855, filed on Aug. 20, 2007, now Pat. No. 8,184,900.
Application No. 11/841,855 is a continuation of application No. 11/674,633, filed on Feb. 13, 2007, now Pat. No. 7,336,821.
Application No. 11/674,633 is a continuation-in-part of application No. 13/079,013, filed on Apr. 3, 2011, now Pat. No. 8,175,342.
Application No. 13/079,013 is a division of application No. 12/042,335, filed on Mar. 5, 2008, now Pat. No. 7,970,182.
Application No. 12/042,335 is a continuation-in-part of application No. 11/462,035, filed on Aug. 2, 2006, now Pat. No. 7,920,723.
Application No. 11/462,035 is a continuation-in-part of application No. 11/282,954, filed on Nov. 18, 2005, now Pat. No. 7,689,009.
Application No. 11/282,954 is a continuation-in-part of application No. 11/936,085, filed on Nov. 7, 2007, now Pat. No. 8,170,294.
Application No. 11/936,085 is a continuation-in-part of application No. 12/302,493, filed on Nov. 25, 2008.
Application No. 12/302,493 is a continuation-in-part of application No. 10/608,784, filed on Jun. 26, 2003.
Application No. 10/608,784 is a continuation-in-part of application No. 13/159,296, filed on Jun. 13, 2011, now Pat. No. 8,155,468.
Application No. 13/159,296 is a continuation of application No. 12/116,140, filed on May 6, 2008, now Pat. No. 7,995,855.
Application No. 12/116,140 is a continuation-in-part of application No. 11/861,854, filed on Sep. 26, 2007, now Pat. No. 8,155,397.
Application No. 11/861,854 is a continuation-in-part of application No. 11/859,164, filed on Sep. 21, 2007, now Pat. No. 8,180,173.
Application No. 11/859,164 is a continuation-in-part of application No. 12/820,034, filed on Jun. 21, 2010, now Pat. No. 8,204,330.
Application No. 12/820,034 is a continuation-in-part of application No. 13/099,335, filed on May 2, 2011, now Pat. No. 8,170,350.
Application No. 13/099,335 is a continuation of application No. 12/881,029, filed on Sep. 13, 2010, now Pat. No. 7,957,597.
Application No. 12/881,029 is a continuation of application No. 12/712,006, filed on Feb. 24, 2010, now Pat. No. 7,796,822.
Application No. 12/712,006 is a continuation of application No. 11/421,027, filed on May 30, 2006, now Pat. No. 7,680,342.
Application No. 11/421,027 is a continuation-in-part of application No. 11/217,788, filed on Aug. 30, 2005, now Pat. No. 7,606,417.
Application No. 11/217,788 is a continuation-in-part of application No. 10/919,226, filed on Aug. 16, 2004, now Pat. No. 7,738,015.
Application No. 10/919,226 is a continuation-in-part of application No. 12/941,983, filed on Nov. 8, 2010.
Application No. 12/941,983 is a continuation-in-part of application No. 12/485,316, filed on Jun. 16, 2009, now Pat. No. 8,199,222.
Application No. 12/485,316 is a continuation-in-part of application No. 12/330,719, filed on Dec. 9, 2008, now Pat. No. 8,264,576.
Application No. 12/330,719 is a continuation-in-part of application No. 11/856,721, filed on Sep. 18, 2007.
Application No. 11/856,721 is a continuation-in-part of application No. 12/824,224, filed on Jun. 27, 2010, now Pat. No. 8,156,095.
Application No. 12/824,224 is a continuation of application No. 11/156,235, filed on Jun. 17, 2005, now Pat. No. 7,747,596.
Application No. 11/156,235 is a continuation-in-part of application No. 13/092,885, filed on Apr. 22, 2011, now Pat. No. 8,195,810.
Application No. 13/092,885 is a continuation of application No. 12/876,209, filed on Sep. 6, 2010, now Pat. No. 7,962,629.
Application No. 12/876,209 is a continuation of application No. 11/294,628, filed on Dec. 2, 2005, now Pat. No. 7,792,970.
Application No. 11/294,628 is a continuation-in-part of application No. 11/156,234, filed on Jun. 17, 2005, now Pat. No. 7,506,057.
Application No. 11/156,234 is a continuation-in-part of application No. 12/026,484, filed on Feb. 5, 2008.
Application No. 12/026,484 is a continuation-in-part of application No. 12/137,113, filed on Jun. 11, 2008.
Application No. 12/137,113 is a continuation-in-part of application No. 13/088,410, filed on Apr. 17, 2011, now Pat. No. 8,270,751.
Application No. 13/088,410 is a continuation of application No. 12/755,338, filed on Apr. 6, 2010.
Application No. 12/755,338 is a continuation of application No. 12/199,710, filed on Aug. 27, 2008, now Pat. No. 7,697,778.
Application No. 12/199,710 is a division of application No. 10/986,562, filed on Nov. 10, 2004, now Pat. No. 7,639,889.
Application No. 10/986,562 is a continuation-in-part of application No. 13/198,624, filed on Aug. 4, 2011, now Pat. No. 8,290,267.
Application No. 13/198,624 is a continuation of application No. 12/824,214, filed on Jun. 27, 2010, now Pat. No. 8,000,526.
Application No. 12/824,214 is a continuation of application No. 11/937,377, filed on Nov. 8, 2007, now Pat. No. 8,036,458.
Application No. 11/937,377 is a continuation-in-part of application No. 12/336,416, filed on Dec. 16, 2008.
Application No. 12/336,416 is a continuation-in-part of application No. 12/913,772, filed on Oct. 28, 2010.
Application No. 12/913,772 is a continuation of application No. 12/437,464, filed on May 7, 2009.
Application No. 12/437,464 is a continuation-in-part of application No. 12/042,104, filed on Mar. 4, 2008, now Pat. No. 8,189,927.
Application No. 12/042,104 is a continuation-in-part of application No. 12/360,665, filed on Jan. 27, 2009.
Application No. 12/360,665 is a continuation-in-part of application No. 12/554,258, filed on Sep. 4, 2009.
Application No. 12/554,258 is a continuation-in-part of application No. 10/764,335, filed on Jan. 22, 2004, now Pat. No. 7,587,068.
Application No. 10/764,335 is a continuation-in-part of application No. 12/551,258, filed on Aug. 31, 2009, now Pat. No. 8,254,674.
Application No. 12/551,258 is a continuation-in-part of application No. 11/233,513, filed on Sep. 21, 2005, now Pat. No. 7,587,085.
Application No. 11/233,513 is a continuation-in-part of application No. 11/123,971, filed on May 6, 2005, now Pat. No. 7,436,998.
Application No. 11/123,971 is a continuation-in-part of application No. 10/976,336, filed on Oct. 28, 2004, now Pat. No. 7,536,036.
Application No. 10/976,336 is a continuation-in-part of application No. 12/960,343, filed on Dec. 3, 2010.
Application No. 12/960,343 is a division of application No. 12/712,126, filed on Feb. 24, 2010.
Application No. 12/712,126 is a continuation of application No. 11/123,972, filed on May 6, 2005, now Pat. No. 7,685,341.
(60) Provisional application No. 60/892,884, filed on Mar. 5, 2007.
(60) Provisional application No. 60/865,375, filed on Nov. 10, 2006.
(60) Provisional application No. 60/865,622, filed on Nov. 13, 2006.
(60) Provisional application No. 60/915,669, filed on May 2, 2007.
(60) Provisional application No. 61/221,467, filed on Jun. 29, 2009.
(60) Provisional application No. 60/893,116, filed on Mar. 5, 2007.
(60) Provisional application No. 60/944,046, filed on Jun. 14, 2007.
(60) Provisional application No. 61/023,774, filed on Jan. 25, 2008.
(60) Provisional application No. 60/893,114, filed on Mar. 5, 2007.
(60) Provisional application No. 61/023,946, filed on Jan. 28, 2008.
(60) Provisional application No. 61/094,034, filed on Sep. 3, 2008.
(60) Provisional application No. 61/094,036, filed on Sep. 3, 2008.
(60) Provisional application No. 61/182,625, filed on May 29, 2009.
(60) Provisional application No. 61/221,455, filed on Jun. 29, 2009.

(30) Foreign Application Priority Data
Jan. 18, 2008 (EP) PCT/EP2008/000378

(51) Int. Cl. H04N 5/225; H04N 5/232; H04N 9/73

(52) U.S. Cl. 348/208.2; 348/349; 348/224.1; 348/352; 348/E05.045; 348/E05.024; 348/E09.052

(57) ABSTRACT

A method operable in a digital image acquisition system having no photographic film is provided. The method comprises receiving a relatively low resolution image of a scene from an image stream, wherein the scene potentially includes one or more faces. At least one high quality face classifier is applied to the image to identify relatively large and medium sized face regions and at least one relaxed face classifier is applied to the image to identify relatively small sized face regions. A relatively high resolution image of nominally the same scene is received and at least one high quality face classifier is applied to the identified small sized face regions in the higher resolution version of said image.

### PRIORITY AND RELATED APPLICATIONS

This application is a continuation-in-part (CIP) of U.S. patent application Ser. No. 11/841,855, filed Aug. 20, 2007 which is a continuation of U.S. patent application Ser. No. 11/674,633, filed Feb. 13, 2007; and

This application is a continuation-in-part (CIP) of U.S. patent application Ser. No. 13/079,013, filed Apr. 3, 2011, which is a divisional of Ser. No. 12/042,335, field Mar. 5, 2008, which claims the benefit of priority to U.S. Provisional Patent Application No. 60/892,884, filed Mar. 5, 2007; which is incorporated by reference, and is also a Continuation-in-Part (CIP) of U.S. patent applications Ser. No. 11/462,035, filed Aug. 2, 2006; and Ser. No. 11/282,954, filed Nov. 18, 2005, now U.S. Pat. No. 7,689,009; and

This application is a continuation-in-part (CIP) of U.S. patent application Ser. No. 11/936,085, filed Nov. 7, 2007, which claims priority to U.S. Provisional Patent Application No. 60/865,375, entitled “A Method of Detecting Redeye in a Digital Image”, filed on Nov. 10, 2006 and to U.S. Provisional Patent Application No. 60/865,622, entitled “A Method of Detecting Redeye in a Digital Image”, filed on Nov. 13, 2006 and to U.S. Provisional Patent Application No. 60/915,669, entitled “A Method of Detecting Redeye in a Digital Image”, filed on May 2, 2007; and

This application is a continuation-in-part (CIP) of U.S. patent application Ser. No. 12/302,493, filed Nov. 25, 2008 which is a United States national stage filing under 35 U.S.C. 371 claiming benefit of priority to PCT application PCT/US2006/021393, filed Jun. 2, 2006, which is a CIP of U.S. patent application Ser. No. 10/608,784, filed Jun. 26, 2003; and

This application is a continuation-in-part (CIP) of U.S. patent application Ser. No. 13/159,296, filed Jun. 13, 2011 which is a continuation of Ser. No. 12/116,140, filed May 6, 2008; and

This application is a continuation-in-part (CIP) of U.S. patent application Ser. No. 11/861,854, filed Sep. 26, 2007; and

This application is a continuation-in-part (CIP) of U.S. patent application Ser. No. 11/859,164 filed Sep. 21, 2007; and

This application is a continuation-in-part (CIP) of U.S. patent application Ser. No. 12/820,034, filed Jun. 21, 2010 which claims priority to provisional patent application No. 61/221,467, filed Jun. 29, 2009; and

This application is a continuation-in-part (CIP) of U.S. patent application Ser. No. 13/099,335, filed May 2, 2011, which is a Continuation of U.S. patent application Ser. No. 12/881,029, filed Sep. 13, 2010; which is a Continuation of U.S. patent application Ser. No. 12/712,006, filed Feb. 24, 2010, now U.S. Pat. No. 7,796,822; which is a Continuation of U.S. patent application Ser. No. 11/421,027, filed May 30, 2006, now U.S. Pat. No. 7,680,342; which is a Continuation-in-part (CIP) of U.S. patent application Ser. No. 11/217,788, filed Aug. 30, 2005, now U.S. Pat. No. 7,606,417; which is a CIP of U.S. patent application Ser. No. 10/919,226, filed Aug. 16, 2004, now U.S. Pat. No. 7,738,015; which is related to U.S. applications Ser. No. 10/635,918, filed Aug. 5, 2003 and Ser. No. 10/773,092, filed Feb. 4, 2004; and

This application is a continuation-in-part (CIP) of U.S. patent application Ser. No. 12/941,983, filed Nov. 8, 2010, which is a Continuation-in Part (CIP) of U.S. patent application Ser. No. 12/485,316, filed Jun. 16, 2009, which is a CIP of Ser. No. 12/330,719, filed Dec. 9, 2008, which is a CIP of U.S. Ser. No. 11/856,721, filed Sep. 18, 2007, which claims priority to U.S. provisional application No. 60/893,116, filed Mar. 5, 2007. This application is also related to U.S. Ser. No. 12/336,416, filed Dec. 16, 2008; and U.S. Ser. No. 11/753,098, filed May 24, 2007; and U.S. Ser. No. 12/116,140, filed May 6, 2008; and

This application is a continuation-in-part (CIP) of U.S. patent application Ser. No. 12/907,921, filed Oct. 19, 2010 Continuation of U.S. patent application Ser. No. 11/753,098, filed May 24, 2007, which claims the benefit of priority under 35 USC .sctn.119 to U.S. provisional patent application No. 60/803,980, filed Jun. 5, 2006, and to U.S. provisional patent application No. 60/892,880, filed Mar. 5, 2007; and

This application is a continuation-in-part (CIP) of U.S. patent application Ser. No. 12/824,224, filed Jun. 27, 2010 which is a Continuation of U.S. patent application Ser. No. 11/156,235, filed Jun. 17, 2005, and this application is related to U.S. patent application Ser. No. 11/156,234, filed Jun. 17, 2005; and

This application is a continuation-in-part (CIP) of U.S. patent application Ser. No. 13/092,885, filed Apr. 22, 2011, is a Continuation of U.S. patent application Ser. No. 12/876,209, filed Sep. 6, 2010; which is a Continuation of U.S. patent application Ser. No. 11/294,628, filed Dec. 2, 2005, now U.S. Pat. No. 7,792,970; which is a Continuation in Part (CIP) of U.S. patent application Ser. No. 11/156,234, filed Jun. 17, 2005, now U.S. Pat. No. 7,506,057; which is related to a contemporaneously filed application having Ser. No. 11/156,235, now U.S. Pat. No. 7,747,596; and

This application is a continuation-in-part (CIP) of U.S. patent application Ser. No. 12/026,484, filed Feb. 5, 2008; and

This application is a continuation-in-part (CIP) of U.S. patent application Ser. No. 12/137,113, filed Jun. 11, 2008, which claims the benefit of priority to U.S. provisional patent application 60/944,046, filed Jun. 14, 2007; and

This application is a continuation-in-part (CIP) of U.S. patent application Ser. No. 13/088,410, filed Apr. 17, 2011 is a Continuation of U.S. patent application Ser. No. 12/755,338, filed Apr. 6, 2010; which is Continuation of U.S. patent application Ser. No. 12/199,710, filed Aug. 27, 2008, now U.S. Pat. No. 7,697,778; which is a Division of U.S. patent application Ser. No. 10/986,562, filed Nov. 10, 2004, now U.S. Pat. No. 7,639,889. This application is related to U.S. Pat. Nos. 7,636,486; 7,660,478; and 7,639,888; and this application is also related to PCT published application WO2006/050782; and

This application is a continuation-in-part (CIP) of U.S. patent application Ser. No. 13/198,624, filed Aug. 4, 2011 which is a Continuation of U.S. patent application Ser. No. 12/824,214, filed Jun. 27, 2010; which is a Continuation of U.S. patent application Ser. No. 11/937,377, filed on Nov. 8, 2007; and this application is related to PCT application no. PCT/EP2008/008437, filed Oct. 7, 2008; and

This application is a continuation-in-part (CIP) of U.S. patent application Ser. No. 12/336,416, filed Dec. 16, 2008, claims priority to U.S. provisional patent application Ser. No. 61/023,774, filed Jan. 25, 2008. The application is also related to U.S. patent application Ser. No. 11/856,721, filed Sep. 18, 2007; and

This application is a continuation-in-part (CIP) of U.S. patent application Ser. No. 12/913,772, filed Oct. 28, 2010, is a Continuation of U.S. patent application Ser. No. 12/437,464, filed on May 7, 2009, which is a Continuation-in-Part (CIP) of U.S. patent application Ser. No. 12/042,104, filed Mar. 4, 2008, which claims the benefit of priority to U.S. patent application No. 60/893,114, filed Mar. 5, 2007; and

This application is a continuation-in-part (CIP) of U.S. patent application Ser. No. 12/360,665, filed Jan. 27, 2009 claims the benefit of priority to U.S. provisional patent application No. 61/023,946, filed Jan. 28, 2008; and

This application is a continuation-in-part (CIP) of U.S. patent application Ser. No. 12/554,258, filed Sep. 4, 2009, is a continuation in part (CIP) of U.S. patent application Ser. No. 10/764,335, filed Jan. 22, 2004, which is one of a series of contemporaneously-filed patent applications including U.S. Ser. No. 10/764,339, now U.S. Pat. No. 7,551,755, entitled, “Classification and Organization of Consumer Digital Images using Workflow, and Face Detection and Recognition”; U.S. Ser. No. 10/764,336, now U.S. Pat. No. 7,558,408, entitled, “A Classification System for Consumer Digital Images using Workflow and User Interface Modules, and Face Detection and Recognition”; U.S. Ser. No. 10/764,335, entitled, “A Classification Database for Consumer Digital Images”; U.S. Ser. No. 10/764,274, now U.S. Pat. No. 7,555,148, entitled, “A Classification System for Consumer Digital Images using Workflow, Face Detection, Normalization, and Face Recognition”; and U.S. Ser. No. 10/763,801, now U.S. Pat. No. 7,564,994, entitled, “A Classification System for Consumer Digital Images using Automatic Workflow and Face Detection and Recognition”; and

This application is a continuation-in-part (CIP) of U.S. patent application Ser. No. 12/551,258, filed Aug. 31, 2009 claims the benefit of priority to U.S. provisional patent applications Nos. 61/094,034 and 61/094,036, each filed Sep. 3, 2008 and 61/182,625, filed May 29, 2009 and 61/221,455, filed Jun. 29, 2009. This application is also a continuation-in-part (CIP) of U.S. patent application Ser. No. 11/233,513, filed Sep. 21, 2005, which is a CIP of U.S. Ser. No. 11/123,971, filed May 6, 2005, now U.S. Pat. No. 7,436,998, which is a CIP of U.S. Ser. No. 10/976,336, filed Oct. 28, 2004, now U.S. Pat. No. 7,536,036. This application is also related to U.S. patent application Ser. Nos. 11/123,971, 11/233,513, 10/976,336, as well as 10/635,862, 10/635,918, 10/170,511, 11/690,834, 10/635,862, 12/035,416, 11/769,206, 10/772,767, 12/119,614, 10/919,226, 11/379,346, 61/221,455 and 61/182,065, and U.S. Pat. Nos. 6,407,777, 7,352,394, 7,042,505 and 7,474,341, and a contemporaneously filed application entitled Optimized Performance and Performance for Red-Eye Filter method and Apparatus by the same inventors listed above; and

This application is a continuation-in-part (CIP) of U.S. patent application Ser. No. 12/960,343, filed Dec. 3, 2010, which is a Division of U.S. patent application Ser. No. 12/712,126, filed Feb. 24, 2010, which is a Continuation of U.S. patent application Ser. No. 11/123,972, filed May 6, 2005, now U.S. Pat. No. 7,685,341; and

All of the above patent applications and patents are hereby incorporated by reference, as well as all other patents and patent applications cited herein.

### FIELD OF THE INVENTION

The present invention provides an improved method and apparatus for image processing in acquisition devices. In particular, the invention provides improved image processing, e.g., face tracking, in a digital image acquisition device, such as a camera phone.

### BRIEF DESCRIPTION OF DRAWINGS

Embodiments of the invention will now be described, by way of example, with reference to the accompanying drawings, in which:

FIG. 1 is a block diagram of a conventional digital image acquisition apparatus. However, certain embodiments of the invention may be combined with one or more features illustrated at FIG. 1.

FIG. 2 is a workflow illustrating a preferred embodiment.

FIG. 3 illustrates schematically a digital image acquisition apparatus according to an embodiment.

### DETAILED DESCRIPTION OF THE EMBODIMENTS

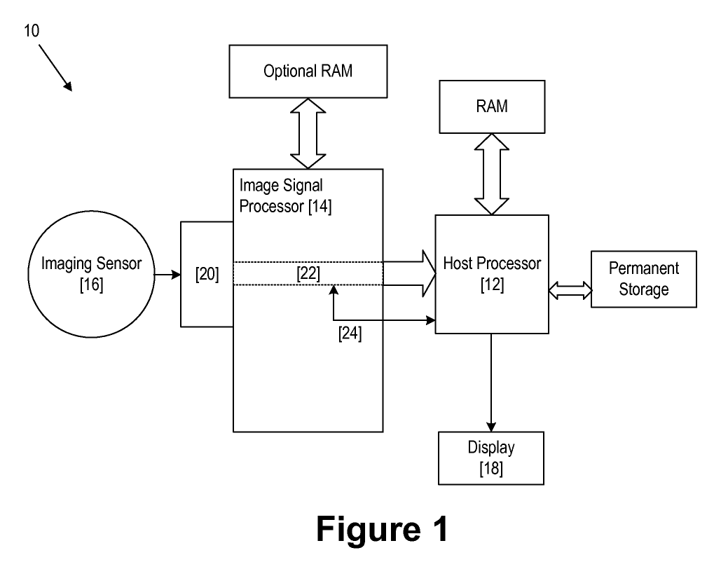

FIG. 1 illustrates digital image acquisition apparatus, for example a camera phone. The apparatus 10 comprises an Image Signal Processor, ISP, 14, which is in general, a general purpose CPU with relatively limited processing power. Typically, the ISP 14 is a dedicated chip or chip-set with a sensor interface 20 having dedicated hardware units that facilitate image processing including image pipeline 22. Images acquired by an imaging sensor 16 are provided to the ISP 14 through the sensor interface 20.

The apparatus further comprises a relatively powerful host processor 12, for example, an ARM9, which is arranged to receive an image stream from the ISP 14.

The apparatus 10 is equipped with a display 18, such as an LCD, for displaying preview images, as well as any main image acquired by the apparatus. Preview images are generated automatically once the apparatus is switched on or only in a pre-capture mode in response to half pressing a shutter button. A main image is typically acquired by fully depressing the shutter button.

Conventionally, high level image processing, such as face tracking, is run on the host processor 12 which provides feedback to the pipeline 22 of the ISP 14. The ISP 14 then renders, adjusts and processes subsequent image(s) in the image stream based on the feedback provided by the host processor 12, typically through an I2C interface 24. Thus, acquisition parameters of the subsequent image in the stream may be adjusted such that the image displayed to the user is enhanced.

Such acquisition parameters include focus, exposure and white balance.

Focus determines distinctness or clarity of an image or relevant portion of an image and is dependent on a focal length of a lens and a capture area of the imaging sensor 16. Methods of determining whether an image is in-focus are well known in the art. For example, if a face region is detected in an image, then given that most faces are approximately the same size and the size of the face within an acquired image, an appropriate focal length can be chosen for a subsequent image to ensure the face will appear in focus in the image. Other methods can be based on the overall level of sharpness of an image or portion of an image, for example, as indicated by the values of high frequency DCT coefficients in the image. When these are highest in the image or a region of interest, say a face region, the image can be assumed to be in-focus. Thus, by adjusting the focal length of the lens to maximize sharpness, the focus of an image may be enhanced.

Exposure of an image relates to an amount of light falling on the imaging sensor 16 during acquisition of an image. Thus an under-exposed image appears quite dark and has an overall low luminance level, whereas an overexposed image appears quite bright and has an overall high luminance level. Shutter speed and lens aperture affect the exposure of an image and can therefore be adjusted to improve image quality and the processing of an image. For example, it is well known that face detection and recognition are sensitive to over or under exposure of an image and so exposure can be adjusted to optimize the detection of faces within an image stream.

Due to the fact that most light sources are not 100% pure white, objects illuminated by a light source will be subjected to a colour cast. For example, a halogen light source illuminating a white object will cause the object to appear yellow. In order for a digital image acquisition apparatus to compensate for the colour cast, i.e. perform white balance, it requires a white reference point. Thus, by identifying a point in an image that should be white, for example the sclera of an eye, all other colours in the image may be compensated accordingly. This compensation information may then be utilised to determine the type of illumination under which an image should be acquired.

While adjusting acquisition parameters such as those described above is useful and can improve image quality and processing, the feedback loop to the ISP 14 is relatively slow, thereby causing delays in providing the ISP 14 with the relevant information to rectify the focus, exposure and white balance of an image. This can mean that in a fast changing scene, adjustment indications provided by the host processor 12 may be inappropriate when they are made by the ISP 14 to subsequent images of the stream. Furthermore, typically most of the processing power available to the host processor 12 is required to run the face tracker application, leaving minimal processing power available for carrying out value added processing.

It is desired to have an improved method of face tracking in a digital image acquisition device.

A method is provided that is operable in a digital image acquisition system having no photographic film. A relatively low resolution image of a scene from an image stream is received. The scene includes one or more faces. At least one high quality face classifier is applied to the image to identify any relatively large sized face regions. At least one relaxed face classifier is applied to the image to identify one or more relatively small sized face regions. A relatively high resolution image of nominally the same scene is also received. At least one high quality face classifier is applied to at least one of said one or more identified small sized face regions in the higher resolution version of the image.

Steps a) to c) may be performed on a first processor, while steps d) and e) may be separately performed on a second processor. Value-added applications may be performed on the high resolution image on the separate second processor.

Step b) and/or step c) may include providing information including face size, face location, and/or an indication of a probability of the image including a face at or in the vicinity of the face region. A weighting may be generated based on the information. Image acquisition parameters of a subsequent image in the image stream may be adjusted based on the information. The adjusted image acquisition parameters may include focus, exposure and/or white balance. The subsequent image may be a preview image or a main acquired image, and it may be displayed to a user.

A high quality face classifier may include a relatively long cascade classifier or a classifier with a relatively high threshold for accepting a face, or both. The relaxed classifier may include a relatively short cascade classifier or a classifier with a relatively low threshold for accepting a face, or both.

A digital image acquisition apparatus is also provided. A first processor is operably connected to an imaging sensor. A second processor is operably connected to the first processor. The first processor is arranged to provide an acquired image to the second processor and the second processor is arranged to store the image. The first processor is arranged to apply at least one high quality face classifier to a relatively low resolution image of a scene from an image stream, the scene including one or more faces, to identify any relatively large sized face regions, and to apply at least one relaxed face classifier to the image to identify one or more relatively small sized face regions. The second processor is arranged to receive a relatively high resolution image of nominally the same scene and to apply at least one high quality face classifier to at least one identified small sized face region in the higher resolution version of the image.

One or more processor-readable storage devices are provided with program code embodied therein for programming one or more processors to perform any of the methods described herein above or below.

Face tracking for digital image acquisition devices include methods of marking human faces in a series of images such as a video stream or a camera preview. Face tracking can be used to indicate to a photographer, locations of faces in an image or to allow post processing of the images based on knowledge of the locations of the faces. Also, face tracker applications can be used in adaptive adjustment of acquisition parameters of an image, such as, focus, exposure and white balance, based on face information in order to produce improved the quality of acquired images.

In general, face tracking systems employ two principle modules: (i) a detection module for locating new candidate face regions in an acquired image or a sequence of images; and (ii) a tracking module for confirming face regions.

A well-known method of fast-face detection is disclosed in US 2002/0102024, incorporated by reference, hereinafter Viola-Jones. In Viola-Jones, a chain (cascade) of 32 classifiers based on rectangular (and increasingly refined) Haar features are used with an integral image, derived from an acquired image, by applying the classifiers to a sub-window within the integral image. For a complete analysis of an acquired image, this sub-window is shifted incrementally across the integral image until the entire image has been covered.

In addition to moving the sub-window across the entire integral image, the sub window is also scaled up/down to cover the possible range of face sizes. It will therefore be seen that the resolution of the integral image is determined by the smallest sized classifier sub-window, i.e. the smallest size face to be detected, as larger sized sub-windows can use intermediate points within the integral image for their calculations.

A number of variants of the original Viola-Jones algorithm are known in the literature, such as disclosed in U.S. patent application Ser. No. 11/464,083, which is assigned to the same assignee and in incorporated by reference.

In the present embodiment, a face tracking process runs on the ISP 14 as opposed to the host processor 12. Thus, more processing power of the host processor is available for further value added applications, such as face recognition. Furthermore, parameters of an acquired image, such as focus, exposure and white balance, can be adaptively adjusted more efficiently by the ISP 14.

As will be appreciated, face tracking applications carried out on high resolution images will generally achieve more accurate results than on relatively lower resolution images. Furthermore, tracking relatively small size faces within an image generally requires proportionally more processing than for larger faces.

The processing power of the ISP 14 is of course limited, and so the arrangement of face tracking application according to the present invention is optimized to run efficiently on the ISP 14.

In the preferred embodiment, a typical input frame resolution is 160 by 120, and face sizes are categorised as small, medium or large. Medium sized and large sized faces in an image are detected by applying 14×14 and 22×22 high quality classifiers respectively, e.g. relatively long cascade classifiers or classifiers with a relatively high threshold for accepting a face.

The distance of a subject face from the acquisition apparatus determines a size of the subject face in an image. Clearly, a first subject face located at a greater distance from the acquisition device than a second subject face will appear smaller. Smaller sized faces comprise fewer pixels and thus less information may be derived from the face. As such, detection of smaller sized faces is inherently less reliable even given the proportionally more processing required than for larger faces.

In the preferred embodiment, small sized faces are detected with a relaxed 7×7 classifier, e.g. a short-cascade classifier or classifier with a lower threshold for accepting a face. Using a more relaxed classifier reduces the processing power which would otherwise be required to detect small sized faces.

Nonetheless, it is appreciated that the application of such a relaxed classifier results in a larger number of false positives, i.e. non-face regions being classified as faces. As such, the adjustment of image acquisition parameters is applied differently in response to detection of small faces and the further processing of images is different for small faces than medium or large faces as explained below in more detail.

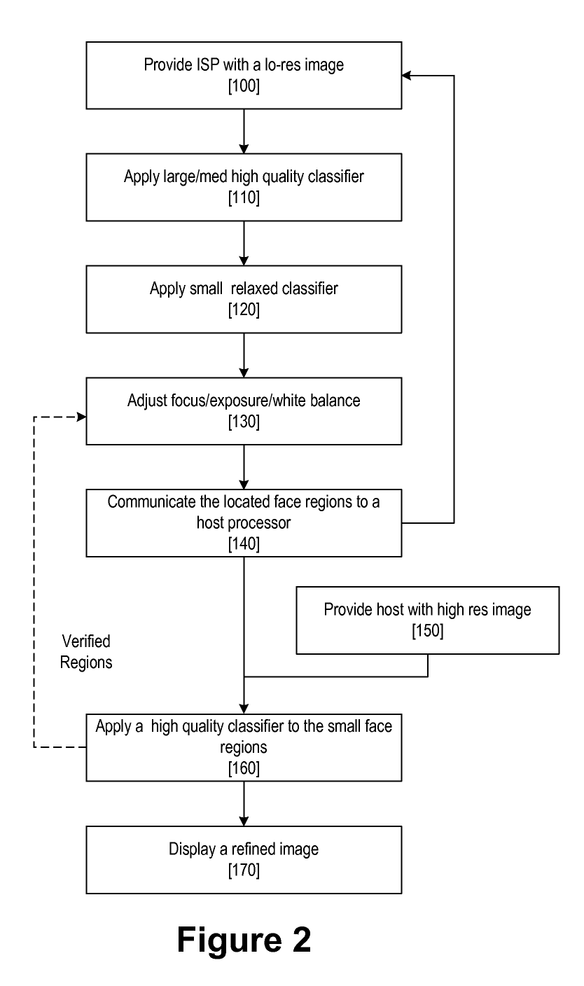

FIG. 2 shows a workflow illustrating a preferred embodiment.

On activation, the apparatus 10 automatically captures and stores a series of images at close intervals so that sequential images are nominally of the same scene. Such a series of images may include a series of preview images, post-view images, or a main acquired image.

In preview mode, the imaging sensor 16 provides the ISP 14 with a low resolution image e.g. 160 by 120 from an image stream, step 100.

The ISP 14 applies at least one high quality classifier cascade to the image to detect large and medium sized faces, step 110. Preferably, both 14×14 and 22×22 face classifier cascades are applied to the image.

The ISP 14 also applies at least one relaxed face classifier to the image to detect small faces, step 120. Preferably, a 7×7 face classifier is applied to the image.

Based on knowledge of the faces retrieved from the classifiers, image acquisition parameters for a subsequent image in the stream may be adjusted to enhance the image provided to the display 18 and/or to improve processing of the image. In the preferred embodiment, knowledge of the faces retrieved from the classifiers is utilised to adjust one or more of focus, exposure and/or white balance of a next image in the image stream, step 130.

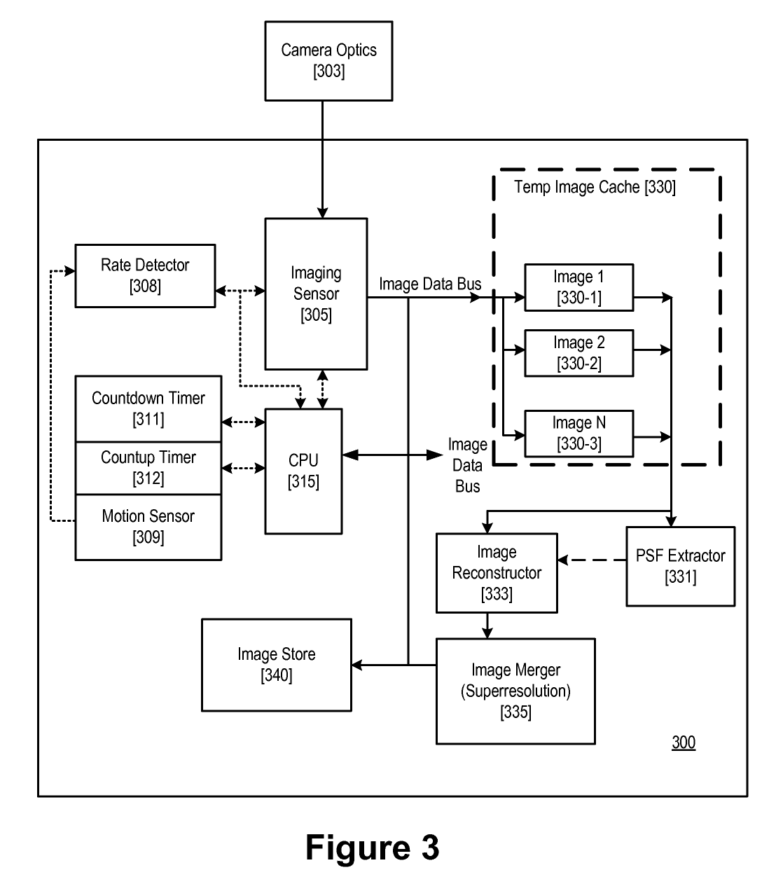

In FIG. 3, a subsystem 331 for estimating the motion parameters of an acquired image and a subsystem 333 for performing image restoration based on the motion parameters for the image are shown coupled to the image cache 330. In the embodiment, the motion parameters provided by the extractor sub-system 331 comprise an estimated PSF calculated by the extractor 331 from the image Cepstrum.

An image merging subsystem 335 connects to the output of the image restoration sub-system 333 to produce a single image from a sequence of one or more de-blurred images.

In certain embodiments some of these subsystems of the apparatus 100 may be implemented in firmware and executed by the CPU; whereas in alternative embodiments it may be advantageous to implement some, or indeed all of these subsystems as dedicated hardware units.

So for example, in a preferred embodiment, the apparatus 300 is implemented on a dual-CPU system where one of the CPUs is an ARM Core and the second is a dedicated DSP unit. The DSP unit has hardware subsystems to execute complex arithmetical and Fourier transform operations, which provides computational advantages for the PSF extraction 331, image restoration 333 and image merging 335 subsystems.

When the apparatus 300 is activated to capture an image, it firstly executes the following initialization steps:
(i) the motion sensor 309 and an associated rate detector 308 are activated;
(ii) the cache memory 330 is set to point to a first image storage block 330-1;
(iii) the other image processing subsystems are reset;
(iv) the image sensor 305 is signaled to begin an image acquisition cycle; and
(v) a count-down timer 311 is initialized with the desired exposure time, a count-up timer 312 is set to zero, and both are started.

The CMOS sensor 305 proceeds to acquire an image by integrating the light energy falling on each sensor pixel; this continues until either the main exposure timer counts 311 down to zero, at which time a fully exposed image has been acquired, or until the rate detector 308 is triggered by the motion sensor 309. The rate detector is set to a predetermined threshold which indicates that the motion of the image acquisition subsystem is about to exceed the threshold of even curvilinear motion which would prevent the PSF extractor 331 accurately estimating the PSF of an acquired image.

In alternative implementations, the motion sensor 309 and rate detector 308 can be replaced by an accelerometer (not shown) and detecting a +/−threshold level. Indeed any suitable subsystem for determining a degree of motion energy and comparing this with a threshold of motion energy could be used.

When the rate detector 308 is triggered, then image acquisition by the sensor 305 is halted; at the same time the count-down timer 311 is halted and the value from the count-up timer 312 is compared with a minimum threshold value. If this value is above the minimum threshold then a useful short exposure time (SET) image was acquired and sensor 305 read-out to memory cache 330 is initiated; the current SET image data is loaded into the first image storage location in the memory cache, and the value of the count-up timer (exposure time) is stored in association with the SET image.

The sensor 305 is then re-initialized for another SET image acquisition cycle, the count-up timer is zeroed, both timers are restarted and a new image acquisition is initiated.

If the count-up timer 312 value is below the minimum threshold, then there was not sufficient time to acquire a valid SET image and data read-out from the sensor is not initiated. The sensor is re-initialized for another short exposure time, the value in the count-up timer 312 is added to the count-down timer 311 (thus restoring the time counted down during the acquisition cycle), the count-up timer is re-initialized, then both timers are restarted and a new image acquisition is initiated.

This cycle of acquiring another SET image 330-n continues until the count-down timer 311 reaches zero. Practically, the timer will actually go below zero because the last SET image which is acquired must also have an exposure time greater than the minimum threshold for the count-up timer 312. At this point, there should be N short-time images captured and stored in the memory cache 330. Each of these SET images will have been captured with a linear or curvilinear motion-PSF.

Knowledge of the faces received from the classifiers comprises information relating to the location of the faces, the size of the faces and the probability of the identified face actually being a face. U.S. patent application Ser. Nos. 11/767,412 and 60/892,883 (FN182/FN232/FN214), which are assigned to the same assignee and the present application and incorporated by reference, discusses determining a confidence level indicating the probability of a face existing at the given location. This information may be utilised to determine a weighting for each face to thereby facilitate the adjustment of the acquisition parameters.

In general, a large face will comprise more information than a relatively smaller face. However, if the larger face has a greater probability of being falsely identified as a face, and/or is positioned at non-central position of the image, it could be allocated a lower weighting even than that of a relatively smaller face, positioned at a centre of the image and comprising a lower probability of being a false positive. Thus, the information derived from the smaller face could be used to adjust the acquisition parameters in preference to the information derived from the large face.

In the embodiment, where only small sized faces are detected in the image, knowledge of the small faces is utilised only to adjust exposure of the next image in the stream. It will be appreciated that although the relaxed classifier passes some false positives, these do not severely adversely influence the adjustment of the exposure.

Focus adjustment is not performed on the next image based on small faces, due to the fact that a lens of the apparatus will be focused at infinity for small faces and there is little to be gained from such adjustment. White balance is not adjusted for small faces because they are considered too small to retrieve any significant white balance information. Nonetheless, each of focus and white balance can be usefully adjusted based on detection of medium and large sized faces.

In the preferred embodiment, once a user acquires a full-sized main image, e.g. by clicking the shutter, and this is communicated to the host, step 150, the detected/tracked face regions are also communicated to the host processor 12, step 140.

In alternative embodiments full-sized images may be acquired occasionally without user intervention either at regular intervals (e.g. every 30 preview frames, or every 3 seconds), or responsive to an analysis of the preview image stream—for example where only smaller faces are detected it may be desirable to occasionally re-confirm the information deduced from such images.

After acquisition of a full-sized main image the host processor 12 retests the face regions identified by the relaxed small face classifier on the larger (higher resolution) main image, typically having a resolution of 320×240, or 640×480, with a high quality classifier, step 160. This verification mitigates or eliminates false positives passed by the relaxed face classifier on the lower resolution image. Since the retesting phase is carried out on a higher resolution version of the image, the small sized faces comprise more information and are thereby detectable by larger window size classifiers. In this embodiment, both 14×14 and 22×22 face classifiers are employed for verification.

Based on the verification, the main image can be adjusted for example, by adjusting the luminance values of the image to more properly illuminate a face or by adjusting the white balance of the image. Other corrections such as red-eye correction or blur correction are also improved with improved face detection.

In any case, the user is then presented with a refined image on the display 18, enhancing the user experience, step 170.

The verification phase requires minimal computation, allowing the processing power of the host processor 12 to be utilised for further value added applications, for example, face recognition applications, real time blink detection and prevention, smile detection, and special real time face effects such as morphing.

In the preferred embodiment, a list of verified face locations is provided back to the ISP 14, indicated by the dashed line, and this information can be utilised to improve face tracking or image acquisition parameters within the ISP 14.

In an alternative embodiment, the verification phase can be carried out on the ISP 14 as although verification is carried out on a higher resolution image, the classifiers need not be applied to the whole image, and as such little processing power is required.

The present invention is not limited to the embodiments described above herein, which may be amended or modified without departing from the scope of the present invention as set forth in the appended claims, and structural and functional equivalents thereof.

In methods that may be performed according to preferred embodiments herein and that may have been described above and/or claimed below, the operations have been described in selected typographical sequences. However, the sequences have been selected and so ordered for typographical convenience and are not intended to imply any particular order for performing the operations.

A camera module in accordance with certain embodiments includes physical, electronic and optical architectures such as those described at one or more or a combination of U.S. Pat. Nos. 7,224,056, 7,683,468, 7,936,062, 7,935,568, 7,927,070, 7,858,445, 7,807,508, 7,569,424, 7,449,779, 7,443,597, 7,768,574, 7,593,636, 7,566,853, 8,005,268, 8,014,662, 8,090,252, 8,004,780, 8,119,516, 7,920,163, 7,747,155, 7,368,695, 7,095,054, 6,888,168, 6,583,444, and 5,882,221, and US published patent applications nos. 2012/0063761, 2011/0317013, 2011/0255182, 2011/0274423, 2010/0053407, 2009/0212381, 2009/0023249, 2008/0296,717, 2008/0099907, 2008/0099900, 2008/0029879, 2007/0190747, 2007/0190691, 2007/0145564, 2007/0138644, 2007/0096312, 2007/0096311, 2007/0096295, 2005/0095835, 2005/0087861, 2005/0085016, 2005/0082654, 2005/0082653, 2005/0067688, and U.S. patent application No. 61/609,293, and PCT applications nos. PCT/US2012/24018 and PCT/US2012/25758, which are all hereby incorporated by reference.

U.S. applications Ser. Nos. 12/213,472, 12/225,591, 12/289,339, 12/774,486, 13/026,936, 13/026,937, 13/036,938, 13/027,175, 13/027,203, 13/027,219, 13/051,233, 13/163,648, 13/264,251, and PCT application WO/2007/110097, and U.S. Pat. Nos. 6,873,358, and RE42,898 are each incorporated by reference into the detailed description of the embodiments as disclosing alternative embodiments.

The following are also incorporated by reference as disclosing alternative embodiments: U.S. Pat. Nos. 8,055,029, 7,855,737, 7,995,804, 7,970,182, 7,916,897, 8,081,254, 7,620,218, 7,995,855, 7,551,800, 7,515,740, 7,460,695, 7,965,875, 7,403,643, 7,916,971, 7,773,118, 8,055,067, 7,844,076, 7,315,631, 7,792,335, 7,680,342, 7,692,696, 7,599,577, 7,606,417, 7,747,596, 7,506,057, 7,685,341, 7,694,048, 7,715,597, 7,565,030, 7,636,486, 7,639,888, 7,536,036, 7,738,015, 7,590,305, 7,352,394, 7,564,994, 7,315,658, 7,630,006, 7,440,593, and 7,317,815, and

U.S. patent applications Ser. Nos. 13/306,568, 13/282,458, 13/234,149, 13/234,146, 13/234,139, 13/220,612, 13/084,340, 13/078,971, 13/077,936, 13/077,891, 13/035,907, 13/028,203, 13/020,805, 12/959,320, 12/944,701 and 12/944,662, and

United States published patent applications Ser. nos. US20120019614, US20120019613, US20120008002, US20110216156, US20110205381, US20120007942, US20110141227, US20110002506, US20110102553, US20100329582, US20110007174, US20100321537, US20110141226, US20100141787, US20110081052, US20100066822, US20100026831, US20090303343, US20090238419, US20100272363, US20090189998, US20090189997, US20090190803, US20090179999, US20090167893, US20090179998, US20080309769, US20080266419, US20080220750, US20080219517, US20090196466, US20090123063, US20080112599, US20090080713, US20090080797, US20090080796, US20080219581, US20090115915, US20080309770, US20070296833 and US20070269108.

In addition, all references cited above and below herein, in addition to the BRIEF DESCRIPTION OF THE DRAWINGS section, as well as US published patent applications nos. US2006/0204110, US2006/0098890, US2005/0068446, US2006/0039690, and US2006/0285754, and U.S. patent applications Nos. 60/773,714, 60/803,980, and 60/821,956, which are to be or are assigned to the same assignee, are all hereby incorporated by reference into the detailed description of the preferred embodiments as disclosing alternative embodiments and components.

In addition, the following United States published patent applications are hereby incorporated by reference for all purposes including into the detailed description as disclosing alternative embodiments:

US 2005/0219391—Luminance correction using two or more captured images of same scene.

US 2005/0201637—Composite image with motion estimation from multiple images in a video sequence.

US 2005/0057687—Adjusting spatial or temporal resolution of an image by using a space or time sequence (claims are quite broad).

US 2005/0047672—Ben-Ezra patent application; mainly useful for supporting art; uses a hybrid imaging system with fast and slow detectors (fast detector used to measure PSF).

US 2005/0019000—Supporting art on super-resolution.

US 2006/0098237—Method and Apparatus for Initiating Subsequent Exposures Based on a Determination of Motion Blurring Artifacts (and 2006/0098890 and 2006/0098891).

The following provisional application is also incorporated by reference: Ser. No. 60/773,714, filed Feb. 14, 2006 entitled Image Blurring

1. A camera phone, comprising:
a housing;
an Image Signal Processor (ISP) configured to detect an object in a stream of relatively low resolution images and to acquire and provide focus information for the object;
an optical system including an imaging sensor configured to be adjusted based on the focus information provided by the ISP to adjust a focus of the object appearing in a subsequently captured image;
a host processor configured to detect the object in a relatively high resolution image and to provide feedback to the ISP to facilitate detecting the object or providing the focus information, or both; and
a display configured to display enhanced versions of the digital images

2. The camera phone of claim 1, wherein the ISP comprises a dedicated chip or chip-set with a sensor interface having dedicated hardware units that facilitate image processing.

3. The camera phone of claim 2, further comprising an image pipeline.

4. The camera phone of claim 1, wherein the display comprises an LCD configured to display said enhanced versions of said digital images.

5. The camera phone of claim 1, wherein the relatively low resolution images comprise preview images, and wherein the display comprises an LCD configured to display said preview images.

6. The camera phone of claim 1, wherein the relatively low resolution images comprise preview images generated automatically when a camera component is switched on or in a pre-capture mode in response to half pressing a shutter button, or both.

7. The camera phone of claim 1, further comprising a sensor interface configured to providing digital images from the imaging sensor to the ISP.

8. The camera phone of claim 1, comprising a gyro-sensor or an accelerometer, or both.

9. The camera phone of claim 1, comprising a dedicated motion detector hardware unit for providing hardware-based control of said sensor to cease capture of an image when a degree of movement of the apparatus in acquiring said image exceeds a first threshold.

10. The camera phone of claim 9, wherein said dedicated motion detector hardware unit comprises a gyro-sensor or an accelerometer, or both.

11. The camera phone of claim 10, comprising one or more controllers configured to cause the sensor to restart capture when a degree of movement of the apparatus is less than a given second threshold and that selectively transfers the digital images acquired by said sensor to said image store.

12. The camera phone of claim 11, comprising a dedicated motion extractor hardware unit configured to provide hardware-based determination of motion parameters of a selected digital image.

13. The camera phone of claim 12, wherein said dedicated motion detector hardware unit comprises a gyro-sensor or an accelerometer, or both.

14. The camera phone of claim 1, further comprising a face tracking module run on the host processor providing feedback to the ISP.

15. The camera phone of claim 14, wherein the ISP is configured to render, adjust and process subsequent images in the image stream based on the feedback provided by the host processor.

16. The camera phone of claim 15, wherein the ISP is configured to adjust said subsequent images in the image stream to generate said enhanced versions of said digital images.

17. The camera phone of claim 1, wherein the ISP is further configured to acquire and provide exposure information for the object for further adjusting said optical system to adjust an exposure of the object appearing in the subsequently captured image.

18. The camera phone of claim 1, wherein the ISP is further configured to acquire and provide white balance information for the object for further adjusting said optical system to adjust a white balance of the object appearing in the subsequently captured image.

19. A digital image acquisition device, comprising:
an image acquisition sensor coupled to imaging optics for acquiring a sequence of images;
an image store for storing one or more of said sequence of images acquired by said sensor;
an accelerometer for providing hardware-based sensor control;
a dedicated motion extractor hardware unit for providing information from the accelerometer of one or more of said sequence of images stored in said image store; and
a processor configured to control said device based on said information.

20. The device of claim 20, comprising a dedicated motion detector hardware unit configured to cause said sensor to cease capture of an image when the degree of movement of the apparatus in acquiring said image exceeds a threshold.

21. The device of claim 20, wherein said dedicated motion detector hardware unit is further configured to selectively transfer said image acquired by said sensor to said image store.

22. The device of claim 19, wherein said information comprises degrees of movement of the device, and wherein the processor is configured to vary exposure times of two or more of said sequence of images based on different degrees of movement of the device.

23. The device of claim 19, further comprising a dedicated image re-constructor hardware unit for providing hardware-based correction of at least one selected image with associated motion parameters.

24. The device of claim 23, further comprising a dedicated image merger hardware unit for providing hardware-based merging of a selected plurality of images including said at least one selected image corrected by said dedicated image re-constructor hardware unit, to produce a high quality image of said scene.

25. The device of claim 19, wherein the accelerometer is configured to detect a +/−threshold level.

26. The device of claim 19, wherein the processor is configured to trigger ceasing exposure when determining that device motion exceeds a threshold amount based on input from the accelerometer and on a calculation based on a non-linear motion formula and exposure time.

27. The device of claim 19, further comprising an Image Signal Processor (ISP) configured to detect an object in a stream of relatively low resolution images and to provide focus information.

28. The device of claim 27, wherein the optical system is configured to be adjusted based on the focus information provided by the ISP to adjust a focus of the object appearing in a subsequently captured image.

29. The device of claim 28, further comprising a host processor configured to detect the object in a relatively high resolution image and to provide feedback to the ISP to facilitate detecting the object and providing the focus information.

30. The device of claim 19, wherein the processor is configured to detect a face including performing the following operations:
receiving a relatively low resolution image of a scene from an image stream, said scene including one or more faces;
applying at least one relatively long face classifier to said image to identify any relatively large sized face regions;
applying at least one relatively short face classifier to said image to identify one or more relatively small sized face regions;
receiving a relatively high resolution image of approximately the same scene; and
applying at least one relatively long face classifier to at least one of said one or more identified small sized face regions in said relatively high resolution image.

31. The device of claim 19, further comprising a second processor coupled to said first processor.

32. The device of claim 31, wherein said first processor is arranged to provide an acquired image to said second processor and said second processor is arranged to store said image.

33. The device of claim 32, wherein said first processor is arranged to apply at least one relatively long face classifier to a relatively low resolution image of a scene from an image stream, said scene including one or more faces, to identify any relatively large sized face regions, and to apply at least one relatively short face classifier to said image to identify one or more relatively small sized face regions.

34. The device of claim 33, wherein said second processor is arranged to receive a relatively high resolution image of approximately the same scene and to apply at least one relatively long face classifier to at least one of said one or more identified small sized face regions in said relatively high resolution image.
